(19) United States
(12) Patent Application Publication
(10) Pub. No.: US 2025/0270926 A1
(43) Pub. Date: Aug. 28, 2025

(54) DRILLING OPERATIONS TELEMETRY FRAMEWORK

(71) Applicant: Schlumberger Technology Corporation, Sugar Land, TX (US)

(72) Inventors: Fatma Mahfoudh, Cambridge (GB); Arnaud Jarrot, Clamart (FR); Arnaud Croux, Clamart (FR)

(21) Appl. No.: 19/064,766

(22) Filed: Feb. 27, 2025

Related U.S. Application Data
(60) Provisional application No. 63/558,320, filed on Feb. 27, 2024.

(51) Int. Cl. E21B 47/18; H04L 27/18

(52) U.S. Cl. CPC E21B 47/18; H04L 27/18; E21B 2200/20; E21B 2200/22

(57) ABSTRACT

A method can include receiving data for field operations using equipment at a site, where the equipment includes a downhole tool on a tool string disposed in a borehole in a geologic environment and a mud pulse telemetry system; determining control parameters for the mud pulse telemetry system using at least a portion of the data and a trained machine learning model; and controlling the mud pulse telemetry system using the control parameters.

### CROSS-REFERENCE TO RELATED APPLICATION(S)

The present disclosure claims priority from U.S. Provisional Appl. No. 63/558,320, filed on Feb. 27, 2024, herein incorporated by reference in its entirety.

### BACKGROUND

A resource field may be an accumulation, pool or group of pools of one or more resources (e.g., oil, gas, oil and gas) in a subsurface environment. A resource field may include at least one reservoir. A reservoir may be shaped in a manner that may trap hydrocarbons and may be covered by an impermeable or sealing rock. A bore may be drilled into an environment where the bore may be utilized to form a well that may be utilized in producing hydrocarbons from a reservoir.

A rig may be a system of components that may be operated to form a bore in an environment, to transport equipment into and out of a bore in an environment, etc. As an example, a rig may include a system that may be used to drill a bore and to acquire information about an environment, about drilling, etc. A resource field may be an onshore field, an offshore field or an on-and offshore field. A rig may include components for performing operations onshore and/or offshore. A rig may be, for example, vessel-based, offshore platform-based, onshore, etc.

Field planning may occur over one or more phases, which may include an exploration phase that aims to identify and assess an environment (e.g., a prospect, a play, etc.), which may include drilling of one or more bores (e.g., one or more exploratory wells, etc.). Other phases may include appraisal, development and production phases.

### SUMMARY

A method can include receiving data for field operations using equipment at a site, where the equipment includes a downhole tool on a tool string disposed in a borehole in a geologic environment and a mud pulse telemetry system; determining control parameters for the mud pulse telemetry system using at least a portion of the data and a trained machine learning model; and controlling the mud pulse telemetry system using the control parameters. A system can include a processor; memory accessible by the processor; processor-executable instructions stored in the memory and executable to instruct the system to: receive data for field operations using equipment at a site, where the equipment includes a downhole tool on a tool string disposed in a borehole in a geologic environment and a mud pulse telemetry system; determine control parameters for the mud pulse telemetry system using at least a portion of the data and a trained machine learning model; and control the mud pulse telemetry system using the control parameters. One or more computer-readable storage media can include processor-executable instructions to instruct a computing system to: receive data for field operations using equipment at a site, where the equipment includes a downhole tool on a tool string disposed in a borehole in a geologic environment and a mud pulse telemetry system; determine control parameters for the mud pulse telemetry system using at least a portion of the data and a trained machine learning model; and control the mud pulse telemetry system using the control parameters. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations may be more readily understood by reference to the following description taken in conjunction with the accompanying drawings.

FIG. 1 illustrates examples of equipment in a geologic environment;

FIG. 2 illustrates examples of equipment and examples of hole types;

FIG. 3 illustrates examples of mud pulse equipment and techniques;

FIG. 4 illustrates an example of a plot;

FIG. 5 illustrates examples of plots;

FIG. 6 illustrates an example of a plot;

FIG. 7 illustrates an example of a model;

FIG. 8 illustrates an example of a portion of a model;

FIG. 9 illustrates an example of a tokenization architecture;

FIG. 10A and 10B illustrates example components of an example of a workflow;

FIG. 11 illustrates an example of a workflow;

FIG. 12 illustrates an example of a system;

FIG. 13 illustrates an example of a method and an example of a system; and

FIG. 14 illustrates an example of computing system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

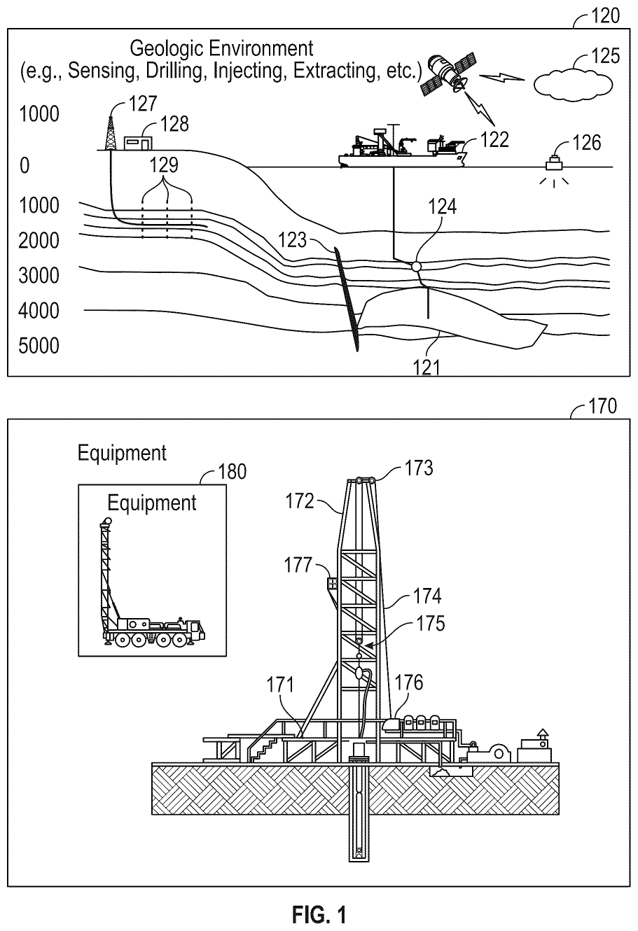

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, injection, production, etc. As an example, the equipment 127 and/or 128 may provide for measurement, collection, communication, storage, analysis, etc. of data such as, for example, production data (e.g., for one or more produced resources). As an example, one or more satellites may be provided for purposes of communications, data acquisition, etc.

FIG. 1 also shows an example of equipment 170 and an example of equipment 180. Such equipment, which may be systems of components, may be suitable for use in the geologic environment 120. While the equipment 170 and 180 are illustrated as land-based, various components may be suitable for use in an offshore system.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block 173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed.

A derrick may be a structure used to support a crown block and a traveling block operatively coupled to the crown block at least in part via line. A derrick may be pyramidal in shape and offer a suitable strength-to-weight ratio. A derrick may be movable as a unit or in a piece-by-piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line may cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block may include a set of pulleys (e.g., sheaves) that may be located at or near a top of a derrick or a mast, over which line is threaded. A traveling block may include a set of sheaves that may be moved up and down in a derrick or a mast via line threaded in the set of sheaves of the traveling block and in the set of sheaves of a crown block. A crown block, a traveling block and a line may form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrickman may be a rig crew member that works on a platform attached to a derrick or a mast. A derrick may include a landing on which a derrickman may stand. As an example, such a landing may be about 10 meters or more above a rig floor. In an operation referred to as trip out of the hole (TOH), a derrickman may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until a time at which it may be desirable to run the pipe back into the bore. As an example, a rig may include automated pipe-handling equipment such that the derrickman controls the machinery rather than physically handling the pipe.

As an example, a trip may refer to the act of pulling equipment from a bore and/or placing equipment in a bore. As an example, equipment may include a drillstring that may be pulled out of a hole and/or placed or replaced in a hole. As an example, a pipe trip may be performed where a drill bit has dulled or has otherwise ceased to drill efficiently and is to be replaced.

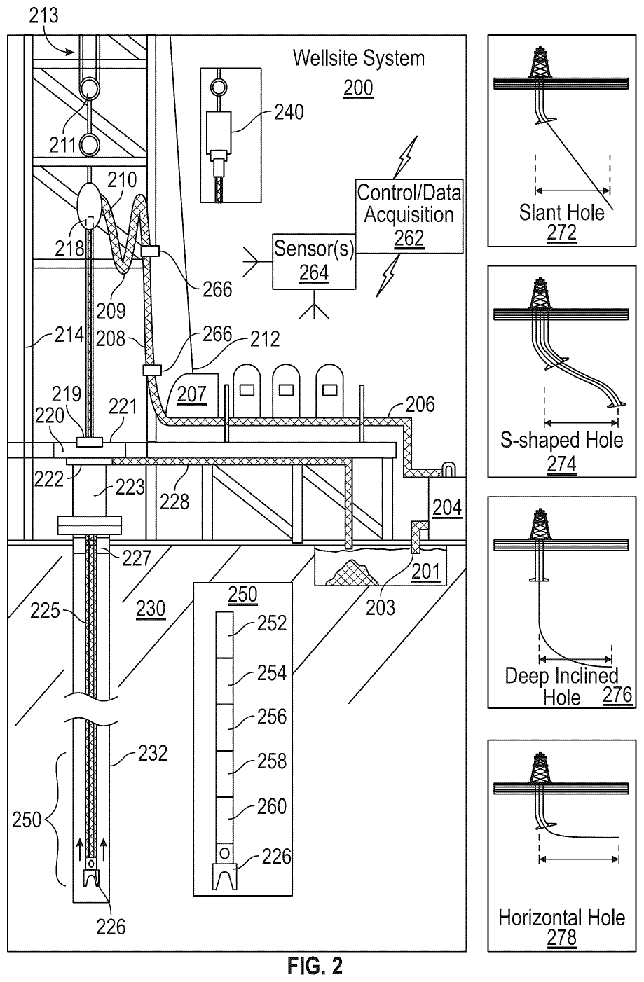

FIG. 2 shows an example of a wellsite system 200 (e.g., at a wellsite that may be onshore or offshore). As shown, the wellsite system 200 may include a mud tank 201 for holding mud and other material (e.g., where mud may be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 may provide for operation of the drillstring 225 and other operations. As shown, the wellsite system 200 includes the platform 211 and the derrick 214 positioned over the borehole 232. As mentioned, the wellsite system 200 may include the rotary table 220 where the drillstring 225 pass through an opening in the rotary table 220.

As shown in the example of FIG. 2, the wellsite system 200 may include the kelly 218 and associated components, etc., or a top drive 240 and associated components. As to a kelly example, the kelly 218 may be a square or hexagonal metal/alloy bar with a hole drilled therein that serves as a mud flow path. The kelly 218 may be used to transmit rotary motion from the rotary table 220 via the kelly drive bushing 219 to the drillstring 225, while allowing the drillstring 225 to be lowered or raised during rotation. The kelly 218 may pass through the kelly drive bushing 219, which may be driven by the rotary table 220. As an example, the rotary table 220 may include a master bushing that operatively couples to the kelly drive bushing 219 such that rotation of the rotary table 220 may turn the kelly drive bushing 219 and hence the kelly 218. The kelly drive bushing 219 may include an inside profile matching an outside profile (e.g., square, hexagonal, etc.) of the kelly 218; however, with slightly larger dimensions so that the kelly 218 may freely move up and down inside the kelly drive bushing 219.

As to a top drive example, the top drive 240 may provide functions performed by a kelly and a rotary table. The top drive 240 may turn the drillstring 225. As an example, the top drive 240 may include one or more motors (e.g., electric and/or hydraulic) connected with appropriate gearing to a short section of pipe called a quill, that in turn may be screwed into a saver sub or the drillstring 225 itself. The top drive 240 may be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 may hold mud, which may be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud may then flow via a passage (e.g., or passages) in the drillstring 225 and out of ports located on the drill bit 226 (see, e.g., a directional arrow). As the mud exits the drillstring 225 via ports in the drill bit 226, it may then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud may be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may be modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud may cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254 (e.g., a LWD tool), a measuring-while-drilling (MWD) module 256 (e.g., a MWD tool), an optional module 258, a roto-steerable system (RSS) and/or motor 260, and the drill bit 226. Such components or modules may be referred to as tools where a drillstring may include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling may commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor may present some challenges depending on factors such as rate of penetration (ROP), transferring weight to a bit (e.g., weight on bit, WOB) due to friction, etc. A mud motor may be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM may be determined or estimated as a sum of the SRPM and the mud motor RPM, assuming the SRPM and the mud motor RPM are in the same direction.

As an example, a PDM mud motor may operate in a so-called sliding mode, when the drillstring is not rotated from the surface to drive a drill bit in a particular cutting direction. In such an example, a bit RPM may be determined or estimated based on the RPM of the mud motor. As an example, during a sliding mode, oscillation of a drillstring may be provided by surface equipment, for example, to oscillate the drillstring in a clockwise and a counter-clockwise direction, which may, for example, help to reduce risk of sticking, etc.

An RSS may drill directionally where there is continuous rotation from surface equipment, which may alleviate the sliding of a steerable motor (e.g., a PDM). An RSS may be deployed when drilling directionally (e.g., deviated, horizontal, or extended-reach wells). An RSS may aim to minimize interaction with a borehole wall, which may help to preserve borehole quality. An RSS may aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and may contain one or a plurality of selected types of logging tools. It will also be understood that more than one LWD and/or MWD module may be employed. Where the position of a module is mentioned, as an example, it may refer to a module at the position of the LWD module 254, the MWD module 256, etc. An LWD module may include capabilities for measuring, processing, and storing information, as well as for communicating with the surface equipment. In the illustrated example, the LWD module 254 may include a seismic measuring device.

The MWD module 256 may be housed in a suitable type of drill collar and may contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller may generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation may include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well may include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of one or more of an RSS, a downhole motor and/or a turbine. As to a motor, for example, a drillstring may include a positive displacement motor (PDM).

As an example, a system may be a steerable system and include equipment to perform a method such as geosteering. As an example, a steerable system may include a PDM or a turbine on a lower part of a drillstring which, just above a drill bit, a bent sub may be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment may make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, may allow for implementing a geosteering method. Such a method may include navigating a subsurface environment, for example, to follow a desired route to reach a desired target or targets.

As an example, a drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering may include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 may be provided for tracking pipe, tracking movement of at least a portion of a drillstring, etc.

As an example, the system 200 may include one or more sensors 266 that may sense and/or transmit signals to a fluid conduit such as a drilling fluid conduit (e.g., a drilling mud conduit). For example, in the system 200, the one or more sensors 266 may be operatively coupled to portions of the standpipe 208 through which mud flows. As an example, a downhole tool may generate pulses that may travel through the mud and be sensed by one or more of the one or more sensors 266. In such an example, the downhole tool may include associated circuitry such as, for example, encoding circuitry that may encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 may include a transmitter that may generate signals that may be transmitted downhole via mud (e.g., drilling fluid) as a transmission medium.

As an example, one or more portions of a drillstring may become stuck. The term stuck may refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this term may refer to a portion of a drillstring that cannot be rotated or moved axially. As an example, a condition referred to as “differential sticking” may be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking may have time and financial cost.

As an example, a sticking force may be a product of the differential pressure between the wellbore and the reservoir and the area that the differential pressure is acting upon. This means that a relatively low differential pressure (delta p) applied over a large working area may be just as effective in sticking pipe as may a high differential pressure applied over a small area.

As an example, a condition referred to as “mechanical sticking” may be a condition where limiting or prevention of motion of the drillstring by a mechanism other than differential pressure sticking occurs. Mechanical sticking may be caused, for example, by one or more of junk in the hole, wellbore geometry anomalies, cement, keyseats or a buildup of cuttings in the annulus.

Various types of data associated with field operations may be 1-D series data. For example, consider data as to one or more of a drilling system, downhole states, formation attributes, and surface mechanics being measured as single or multi-channel time series data.

Mud pulse telemetry (MPT) can provide for transmission of information relating to downhole parameters and/or conditions that may pertain to formation characteristics traversed along a borehole. As an example, LWD technology may employ an MPT system. As an example, an MPT system may transmit signals using a communication channel formed by a column of drilling fluid in a bore of drill pipe, for example, using a downhole transmitter and a surface receiver (e.g., and/or vice versa).

As an example, equipment at a site may include dual-telemetry control equipment that may provide for uplinks (e.g., transmission to surface of sensor data and/or other information) and downlinks where a downlink may, for example, provide for instructing downhole equipment (e.g., switch between telemetry modes, configure telemetry, instruct one or more directional drilling tools, instruct one or more data acquisition tools, etc.). As an example, downlinking may include temporary interruption of drilling operations so that one or more mud pumps at surface may be operated to create pulses, which may be detectable using one or more downhole receivers. While mud pumps are mentioned, one or more other techniques may be utilized. For example, consider a downlink system that include at least one mud pump for pumping drilling fluid from a drilling fluid storage tank to a drilling system via a standpipe where a return line is provided for transporting the fluid back to the storage tank. In such an example, a drilling fluid modulator may be in fluid communication with either the standpipe or the return line. As an example, a flow modulator may be placed on a bypass line. As an example, a downlink system may include a flow restrictor, which may provide resistance to high pressure mud flow and therefore help to protect a flow modulator. In such an example, the downlink system may include a flow diverter, which may help to reduce turbulence of mud flow.

As explained, drilling fluid may be used to lubricate and cool downhole drillstring components, carry cuttings from a bottom of a borehole to surface, and balance hydrostatic pressure in formations. As an example, an MPT system can use coded drilling fluid pressure signal pulses generated using downhole equipment that propagate through drilling fluid (e.g., mud) to surface equipment where they may be detected and decoded for interpretation; noting that downlinking, where available, may provide for transmission of mud pulses that may be detectable by downhole equipment. In various instances, bandwidth demands for transmission uphole to surface may be greater than bandwidth demands for transmission downhole to a downhole tool. For example, transmission uphole may be for one or more types of sensor data, which may be acquired at a desired frequency and transmitted and/or stored and later transmitted. Such data may be assessed to determine one or more conditions that may provide for improved control of field operations (e.g., drilling operations). In various instances, a downlink may be a control command, which may be a relatively lightweight command (e.g., in terms of size compared to sensor data).

As an example, an MPT system may utilize a valve to controllably restrict flow of drilling fluid, which, in turn, generates pressure waves that may travel within a continuous column of the drilling fluid (e.g., within a bore of drill pipe of a drillstring). In such an example, the pressure waves may travel at varying speeds depending on one or more factors such as, for example, drilling fluid properties. As an example, controlled pressure pulse variations downhole may be used to modulate amplitude, phase and/or frequency of mud pulse signals. As an example, a surface received signal can be responsive to pulse variations related to downhole measured data (e.g., LWD data, etc.).

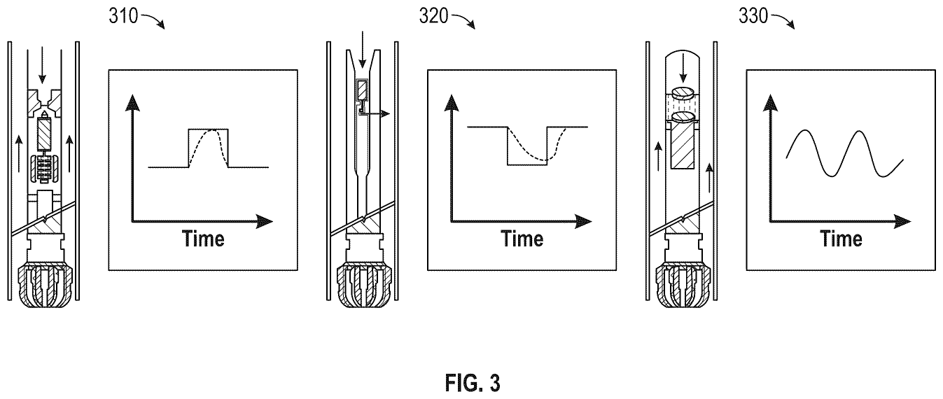

FIG. 3 shows some examples of portions of MPT systems 310, 320 and 330, which may be utilized to generate mud pulses. For example, the systems 310, 320 and 330 may generate one or more streams using techniques for mud pulse pressure pulses such as positive-pulse per the MPT system 310, negative-pulse (e.g., annular-venting telemetry) per the MPT system 320, and continuous-wave (e.g., mud siren) waves per the MPT system 330.

As an example, telemetry system may include links, for example, consider a two-link system with three nodes where a middle node (e.g., intermediate node) may be considered a repeater. As an example, a framework may provide for planning and/or controlling operation of a single link and/or a multi-link telemetry system.

As an example, in a telemetry system, pressure pulses generated by poppet pulsers can form positive-pulse and negative-pulse (annular-venting telemetry) that may be discrete pressure waves; siren pulsers can generate continuous wave pulses that can be periodic; and rotationally oscillating shear-valve pulsers can generate discrete pulses and/or continuous wave signals. Such generated mud pulsar series may be recognizable by surface signal-processing equipment.

Transmitted pulse signals including information may be encoded by one or more of various techniques, for example, in advance before they propagate to surface for detection and decoding. Surface pressure transducers tend to detect signals weakened by signal strength degradation (attenuation), erosion, pressure drop across a borehole and/or one or more other signal impairment effects. As explained, received information may include, for example, logging data, parameters of pressure, temperature, drill bit direction, deviation, etc. As explained, logging data may include electrical conductivity of the various formation layers, acoustic and nuclear properties, porosity, induction, pressure gradients, etc. To improve drilling operations, an MPT system may include various features to recover transmitted signals with acceptable fidelity.

As an example, one or more types of MPT system signal impairments may be experienced. For example, mud channel signals may experience pressure fluctuations and uncertainty caused by various MPT system components that potentially change signal properties during course of data transmission. As an example, noise sources that induce pressure fluctuations can include one or more of mud pumps, pulsation dampeners, surface piping, pressure transducer locations, drill string components, mud properties, well depth, etc. In various instances, a mud channel that pulse signals pass as they propagate to surface can be relatively harsh, demanding complex surface signal detection and extraction. Mud pulse signal property distortions that may degrade signal transmission and data rates can relate to downhole signal strength, signal attenuation, surface induced noise (electrical noise) and surface piping induced signal reflections. Unpredictable and complex adjustable signal impairments may be caused by drilling noise, drill string motion noise within a borehole, attenuation and mud pump noise. Depending on severity of mud channel conditions and signal distortions, to achieve maximum possible data rates, telemetry systems may be configured to be robust and flexible, downhole and/or at surface.

As an example, an MPT system may utilize frequencies within a frequency range from approximately 1 Hz to approximately 20 Hz (e.g., as may be utilized for various LWD MPT systems). In various instances, mud pump noise may interfere with such frequencies. Further, as MPT system signals propagate through drilling mud along a borehole, signals can be attenuated and dispersed. For example, consider underbalanced drilling mud which may result in viscous dissipation and frictional energy loss at borehole walls. Changes in drilling mud compressibility (e.g., due to gas introduction, gas evolution, etc.) may result in risk of formation damage, which may affect shape of signal pulses and complicate decoding. Factors influencing mud pulse signal attenuation can include borehole depth, drilling mud type, number of joints in a drill string, drillstring inner diameter and signal operating frequency. Attenuation impacts may not be the same across a range of frequency components, for example, lower frequency components may be subject to less attenuation than higher frequencies. Devising good control of the various noise sources in a 1 Hz to 20 Hz frequency band may be helpful for transmitting MPT data at a lowest possible frequency to minimize signal attenuation impacts. In some high data rate exploration and drilling operation applications, signal attenuation may be of a lesser burden than various noise sources and their distribution across an available channel transmission band.

In various instances, pulsars in MPT telemetry may create signals that also propagate in a reverse direction, whereby down-going signals may reflect at a drill bit and then combine to create constructively or destructively interfering signals. Signal reflections may be detected at one or more surface signal detectors as caused by one or more of mud pumps, pulsation dampeners, drill string joints and diameter changes, and dispersion and filtering of certain frequencies within a mud channel. The ultimate signal that travels up a drill pipe may depend on mud velocity, position of a pulsar in a drill collar, operating frequency and BHA details forming a host waveguide. Signal reflections may occur at one or more impedance mismatch positions in a drillstring, hence, equipment and/or operations may aim to reduce such mismatches. In various instances, multiple-echo suppression may be employed, for example, using multiple receivers based on transient pulse responses in uplink and downlink channels.

As mentioned, formation properties may affect MPT. For example, rock formation solid particles, free gas volume fraction and mud channel compressibility may affect mud pulse velocity and signal attenuation. As mud solids and free gas content increase, mud density and mud compressibility changes may decrease mud pulse velocity, which can add complexity to signal transmission speed. As an example, an initial mud pulse propagation velocity model may consider drilling fluid to be a single phase; however, drilling fluid can be a multiphase fluid, which may include clay, formation cuttings of various sizes, barite, and free gas mixed with water or oil, which may affect mud bulk modulus; noting that water-based mud velocity tends to be higher than that of oil-based mud. In various instances, if gas influx is not offset in time, an unstable effect may escalate into detrimental well blowout.

As to downhole sources of random noise, these can include pressure fluctuations caused by bit vibration, drilling motor stalling and the drill bit interaction with formation being drilled. Mechanical rig vibration and electrical noise coupling into the electrical wiring that carries electrical signals from sensors to a signal receiver may degrade telemetry signal detection and extraction. Such noises may present a band-limited white Gaussian noise due to a lower noise frequency spectrum. While random noise frequencies may tend to be relatively small, they can affect certain signal frequency bands, causing relatively larger random pressure amplitude fluctuations and may lower downhole signal-to-noise ratio (SNR).

As explained, various signal impairments may degrade quality of surface received signals and may complicate telemetry signal detection and extraction. As an example, a framework may aim to provide for improved MPT, particularly to improve recovery of transmitted signals for LWD facilitated operations.

As an example, a framework may implement a machine learning model to configure one or more parameters of an MPT system. For example, consider a machine learning model that may be or include a deep ensemble residual network for hybrid MPT planning and operation.

As an example, a framework may be implemented to select telemetry parameters when planning a job. Such a framework may include a Deep Ensemble Residual Neural Network (Deep-Ens-ResNet) to model information bit confidence and combine the information bit confidence with outcome of a physics-based model to achieve a hybrid approach (e.g., a combination of machine learning-based and physics-based approaches). As an example, a Deep-Ens-ResNet may be trained using historical data such that a trained model allows for output of estimated bit confidence and uncertainty around an estimation, which may be utilized in decision making, whether performed by a human and/or a machine, to decide when to trust a model prediction.

As an example, bit confidence may be utilized as a metric to characterize quality of transmission (e.g., on a bit basis). For example, if bit confidence is high, then transmission quality may be considered to be high; whereas, if bit confidence is low, then transmission quality may be considered to be low. As an example, one or more thresholds may be utilized to categorize transmission quality using one or more bit confidence metrics.

As explained, MPT may be implemented to transmit data (e.g., LWD data and/or MWD data) acquired downhole to surface, using pressure pulses in a mud system. Measurements may be converted into an amplitude-or frequency-modulated pattern of mud pulses. In various instances, an MPT system may be used bi-directionally, for example, to transmit commands from surface to downhole (e.g., downlinks). As an example, measurements made downhole, may be stored in solid-state memory for some amount of time and later transmitted to surface (e.g., and/or retrieved at surface upon pulling equipment out of hole). Data transmission may involve digitally encoding data and transmitting encoded data to the surface as pressure pulses in the mud system.

As an example, pressure pulses may be generated by a rotor/stator pair of an MWD module (e.g., MWD tool) as the rotor obstructs flow through the stator, controllably (e.g., periodically). As an example, a physics-based model may be utilized for planning that aims to model attenuation and reflections of pressure waves in drilling fluid as they travel from a downhole modulator to surface via piping. Such a model may be used prior to normal drilling operations to estimate a suitable telemetry band to be used. For example, consider telemetry estimated parameters that can include mode (e.g., telemetry method for power up), frequency (Hz) and bit rate (transmission speed in bit per second (bps)).

In various telemetry operations, fundamental operational parameters to be selected can include: carrier frequency (e.g., center frequency around which a telecommunication signal is transmitted); and symbol rate (e.g., transmission speed of a telecommunication system, which may be closely related to bandwidth occupancy of the transmitted signal). Such parameters may be carefully selected to make drilling of a section as smooth and reliable as possible. To do so, several operational aspects may be considered, which can include attenuation, channel, and noise. As to attenuation, as drilling of a section progress and a tool gets deeper within a borehole (e.g., along measured depth and/or true vertical depth), such that a communication signal becomes more attenuated. Such attenuation may be managed in such a way that at an end of a section, energy of the signal at surface is high enough to be received error-free. As to channel, speed of a telemetry signal tends to be relatively slow, for example, travelling at speed of sound in mud at approximately 1000 m/s. This relatively low propagation speed combined with change of acoustic impedance along a propagation path, can create severe signal distortions caused by multiple reflections in the propagation channel. As to noise, it may present various challenges to MPT, which, as explained, may be due to one or more sources (e.g., mud pump noise, drilling noise, electrical noise, etc.).

The ability to send information through a communications channel can be limited by a certain maximum transmission rate, which may be referred to as the bandwidth of the channel. According to information theory, even in a noisy channel with a relatively low bandwidth, essentially perfect, error-free communication may be achieved by keeping the transmission rate within the channel's bandwidth and by using error-correcting schemes: the transmission of additional bits that enable the data to be extracted from the noise-ridden signal (see, e.g., Shannon, C. E. (1948), “A Mathematical Theory of Communication”, Bell System Technical Journal, 27, 379-423).

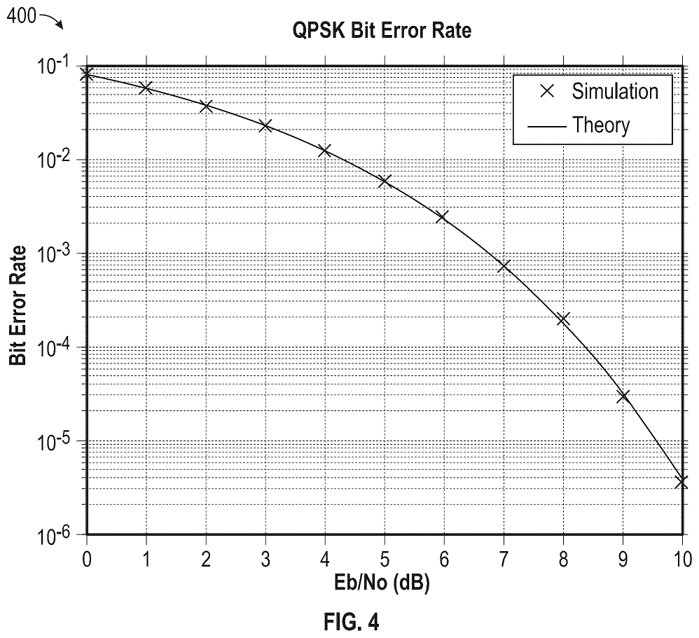

FIG. 4 shows an example of a plot 400 of bit error rate (BER) versus so-called signal-to-noise ratio (SNR). The ratio of signal energy measured at surface against noise may be used to establish SNR or more precisely energy per bit to noise power spectral density ratio (Eb/NO) in the case of a telecommunication system, which defines performance of the system. In the plot 400 of FIG. 4, (BER) versus SNR for a QPSK modulation technique is shown. As seen, below approximately 8 dB, reliability of the system is substantially impacted with probability of error of 2×10⁴. While QPSK is mentioned in the example of FIG. 4, one or more other techniques may be employed, which may include one or more other phase-shift keying (PSK) techniques. PSK may be defined as a digital modulation process which conveys data by changing (e.g., modulating) phase of a constant frequency carrier wave. As an example, modulation may be accomplished by varying the sine and cosine inputs at a precise time. As an example, one or more of amplitude-shift keying (ASK, e.g., OOK, etc.), frequency-shift keying (FSK), PSK, orthogonal frequency-division multiplexing (OFDM), trellis-coded modulation (TCM), etc., may be utilized.

As an example, during an operation, if error rate drops below 1e⁻³, a workflow may call for the carrier frequency and the bit rate to be updated in an effort to improve the SNR. In such an example, updating may be achieved via use of a flow-rate downlink, which tends to be a time-consuming and costly operation (e.g., via introduction of non-productive time (NPT), etc.). As explained, downlinking may involve temporarily halting drilling and/or one or more other operations. Further, downlinking may be combined with uplinking, for example, where an uplink is transmitted to confirm receipt of a downlink.

For one or more reasons, downlinking may be undesirable or otherwise limited. As explained, where error rate drops below a threshold (e.g., a low SNR), there may be a desire to adjust one or more telemetry parameters. However, in various instances where telemetry parameters may be more optimally chosen in advance of demand for mud pulse telemetry, there may be a lesser need (e.g., or no need) for downlinking.

To limit the risk of reaching a low SNR during drilling of a section, planning may be utilized that provides for estimating the most likely usable telemetry parameters. As explained, drilling of a borehole may occur in sections where, as the borehole becomes longer, the sections may increasingly diminish in size (e.g., borehole diameter). Accordingly, a drillstring may be pulled out of hole (POOH) at the end of a section where a BHA and/or one or more other components are selected for drilling the next section. In such an approach, telemetry parameters may be programmed at surface, for example, prior to running a drillstring in hole (RIH). While demand for downlinking may be reduced or eliminated via appropriate planning, one or more techniques may provide for improved telemetry parameters that may be communicated via downlinking, where warranted, though at a possible cost (e.g., time, resources, etc.). Overall, proper planning may provide for improved data quality, improved amounts of data, fewer interruptions to drilling of a section, etc.

As to planning, as an example, a physics-based model telemetry planner may be implemented, which may encapsulate years of theoretical and experimental knowledge related to the behavior of acoustic waves in drilling mud. Such a planner may be able to simulate propagation of a telemetry signal to surface using a numerical simulation technique such as, for example, a finite element numerical simulation technique where physics-based equations are discretized to account for physical phenomena such as, for example, attenuation, reflections, etc. However, such a planner may, at times, not be implemented or implemented infrequently as it may lack accuracy and/or demand several hours of interaction for input data collection.

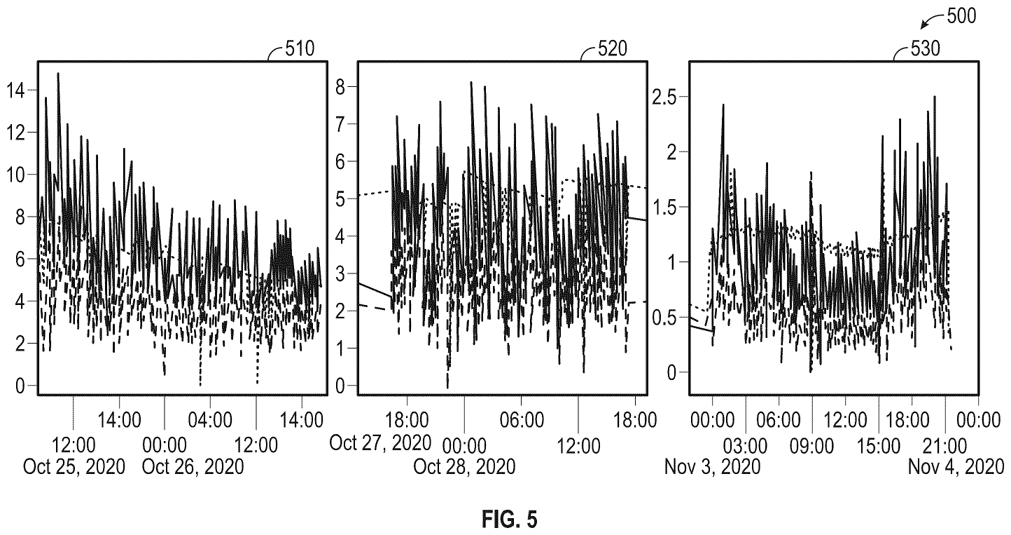

FIG. 5 shows example plots 510, 520, and 530 of comparing true signals (SPT1 and SPT2 (Signal Pressure Transducers)) to a predicted signal by a planner such as, for example, the aforementioned numerical simulation technique-based planner. Although the predicted signal follows the global trend of true signals, the error tends to be relatively high. In the plots, the SPT1 is shown in purple, SPT2 is shown in red and the predicted signal strength is shown in green.

Several reasons can exist as to why such types of mismatches can be observed during operations. For example, consider slight model deviation, change in operational conditions, etc. Overall, a planner may be quite sensitive to accuracy of inputs to the planner's model where small mismatches can create large variations in predicted values. As an example, to improve planning, output of a physics-based model planner may be complemented through use of historical datasets, which may, for example, have been recorded in the same or similar locations, for example, in an effort to fill a gap in input inaccuracies by leveraging historical data.

As an example, a framework may employ a machine learning model of bit confidence trained with historical data. In such an example, the framework may provide for complementing a physics-based model such as that of a physics-based model planner. As explained, a framework may provide for implementation of a hybrid approach that utilizes one or more machine learning-based models and one or more physics-based models.

As an example, a metric referred to as bit confidence may be utilized to describe a figure of merit related to reliability of telemetry decoding. For a QPSK modulation, the Log Likelihood Ratio (LLR) Bit Confidence may be defined as follows:

$$\begin{matrix}LLR ( {b}_{1 k} ) = - {d}_{1}^{2} + {d}_{2}^{2} \\ LLR ( {b}_{2 k} ) = - {d}_{2}^{2} + {d}_{3}^{2} \\ LLR Bit {Confidence}_{QPSK} ( {b}_{1} ) = min \{ 50 x \vert LLR ( {b}_{1} ) \vert , 100 \} \\ LLR Bit {Confidence}_{QPSK} ( {b}_{2} ) = min \{ 50 x \vert LLR ( {b}_{2} ) \vert , 100 \}\end{matrix}$$

where dₘ represents the Euclidian distance between the estimated symbol and the constellation center of the symbol (e.g., m may be 1, 2, 3, etc.), for example, within a multidimensional space (e.g., a multidimensional graph, plot, etc.); noting that the subscript k may be utilized to distinguish bit information and symbol information.

As an example, a bit confidence metric may be a maximum at high SNR where the symbols are close to the matching constellation center. As explained, a distance may be utilized to characterize a difference between what is received and what is supposed to be received (e.g., whether in simulation and/or in an actual system).

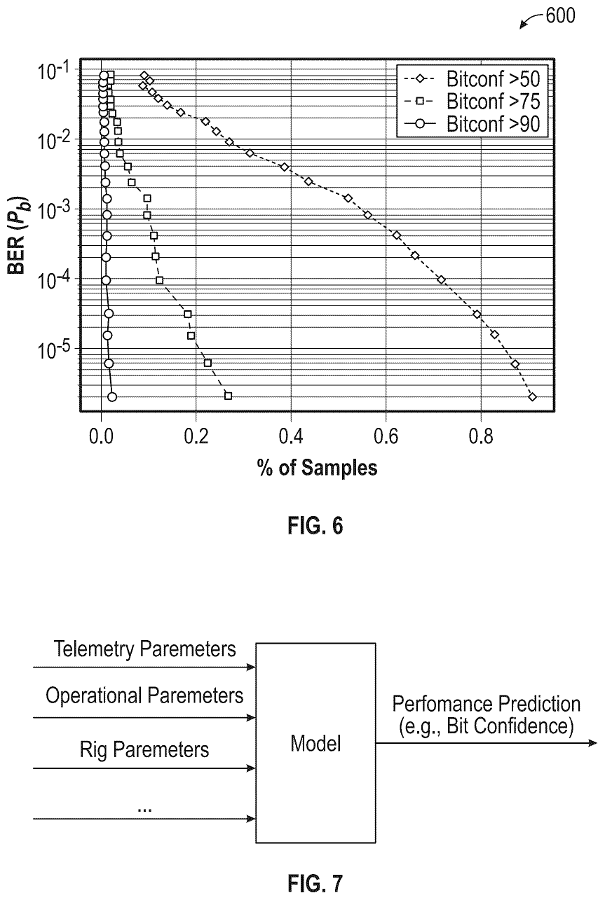

FIG. 6 shows an example plot 600 of simulation results for estimated bit confidence against BER (e.g., BER probability versus percentage of samples for different bit confidence levels). As can be seen, as the BER degrades, there is a strong reduction in the percentage of points above a given threshold. In the example of FIG. 6, the plot indicates bit confidence metric values of greater than 50, greater than 75 and greater than 90. As shown, where bit confidence is less, the percentage of samples with various levels of BER increases. As explained, bit confidence can be utilized as a metric to characterize transmission quality (e.g., via BER, etc.). The plot 600 may be viewed as a reliability plot, indicating deterioration in bit quality.

FIG. 7 shows an example model with input and output for performance prediction (e.g., bit confidence prediction), where, for example, input can include various parameters, which may include one or more of telemetry parameters, operational parameters, rig parameters, etc. Such a model may be utilized to predict reliability of a telemetry system (e.g., quality of performance, etc.), for example, by prediction of bit confidence. As shown, various parameters may be utilized, which may include geographic, geologic, equipment, operational, etc., types of parameters. Such parameters may be available in one or more databases as to jobs performed at one or more sites (e.g., rig sites, wellsites, etc.).

As to a model for performance prediction, it may aim to capitalize on extensive historical data encompassing various job types and operations, including telemetry mode details (e.g. data rate and carrier frequency), rig parameters (e.g. location), and attributes related to the operational parameters used for the job (e.g., mud parameters, BHA specifications, etc.). As an example, a machine learning approach may explore various features as to their potential as inputs for training one or more machine learning models (e.g., consider feature engineering, etc.). As explained, a trained machine learning model (e.g., ML model) may be implemented by a framework for predicting performance of a telemetry system. As an example, output may be utilized to tailor input, for example, in an iterative loop where telemetry parameters may be tailored (e.g., optimized); noting that various parameters may be fixed (e.g., location) or otherwise not amenable to tailoring or substantial tailoring (e.g., section sizes of a planned borehole, etc.).

As mentioned, an ML model may be or include a ResNet or Residual Neural Network, as a deep learning type of model in which weight layers may learn residual functions with reference to layer inputs. A Residual Network can be a network with skip connections that may perform identity mappings, for example, merged with layer outputs by addition. As an example, one or more other types of models may be utilized, additionally or alternatively. As an example, consider one or more of dense layers of fully connected neural networks, gradient-based models (e.g., XGBoost, Light Gradient Boosting Machine (LGBM), CATBoost, etc.), etc. In various instances where a sufficient amount of data may be available from various telemetry jobs (e.g., sufficiently representative), a deep learning type of model may be utilized.

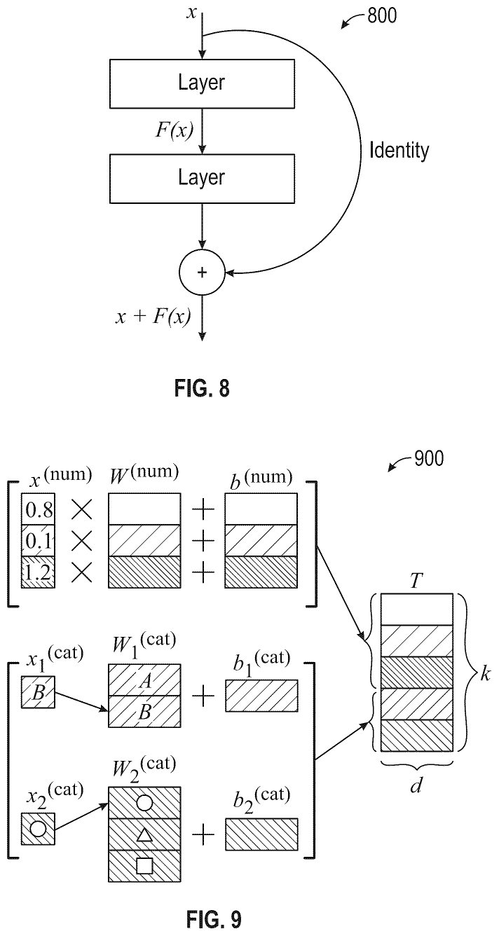

FIG. 8 shows an example of a portion of a deep residual network, in particular, a residual block 800. Such a block may find use in neural networks that provide for computer vision; noting that a framework may utilize such a block with tabular data rather than raster (e.g., pixel) images. As an example, a framework may provide for presenting data in the form of an image or images (e.g., via coding of data in a manner representable by pixels).

As an example, for a ResNet, tabular data may be represented as follows:

$$\begin{matrix}Res Net ( x ) = Prediction ( Res NetBlock ( … ( Res NetBlock ( Linear ( x ) ) ) ) ) \\ Res NetBlock ( x ) = x + Dropout ( Linear ( Dropout ( ReLU ( Linear ( Batch Norm ( x ) ) ) ) ) ) \\ Prediction ( x ) = Linear ( ReLU ( Batch Norm ( x ) ) )\end{matrix}$$

FIG. 9 shows an example of an architecture 900 for encoding categorical features. In particular, the architecture 900 shows components of a feature tokenizer. As shown, in the example of FIG. 9, a feature tokenizer may handle categorical input (see, e.g., x₁ and x₂) and may also handle numeric input. As an example, a feature tokenizer may be implemented to convert input x into an embedding T∈R^{(k×d)}. As explained, input regarding categories may be transformed into values. As an example, a tokenizer may operate by splitting categorical input (e.g., text) into tokens, for example, according to a set of rules. Such tokens may then be converted into numbers, which may be utilized to build tensors as input to a model. As explained, additional input for a model may also be added by a tokenizer. As an example, various types of inputs to a model may be categorical and/or numeric inputs.

As an example, a framework may utilize a deep ensemble approach, for example, with a ResNet type of architecture. In such an example, the deep ensemble approach may include training a set of M neural networks with random weight initialization (e.g., consider a set of ResNet models, etc.). These networks may include two outputs: the mean μ(x) and the variance σ²(x). By treating the observed value as a sample from a Gaussian distribution with the predicted mean and variance, a workflow may include minimizing the negative log-likelihood criterion:

$$- log {p}_{θ} ( {y}_{n} \vert {x}_{n} ) = \frac{log {σ}_{θ}^{2} ( x )}{2} + \frac{{( y - {μ}_{θ} ( x ) )}^{2}}{2 {σ}_{theta}^{2} ( x )} + constant$$

As an example, an ensemble may be treated as a uniformly-weighted Gaussian mixture model with mean and variance as follows:

$$\begin{matrix}{μ}_{*} ( x ) = \frac{1}{M} {\sum }_{m} {μ}_{{θ}_{m}} ( x ) \\ {σ}_{*}^{2} ( x ) = \frac{1}{M} {\sum }_{m} ( {σ}_{{θ}_{m}}^{2} ( x ) + {μ}_{{θ}_{m}}^{2} ( x ) ) - {μ}_{*}^{2} ( x )\end{matrix}$$

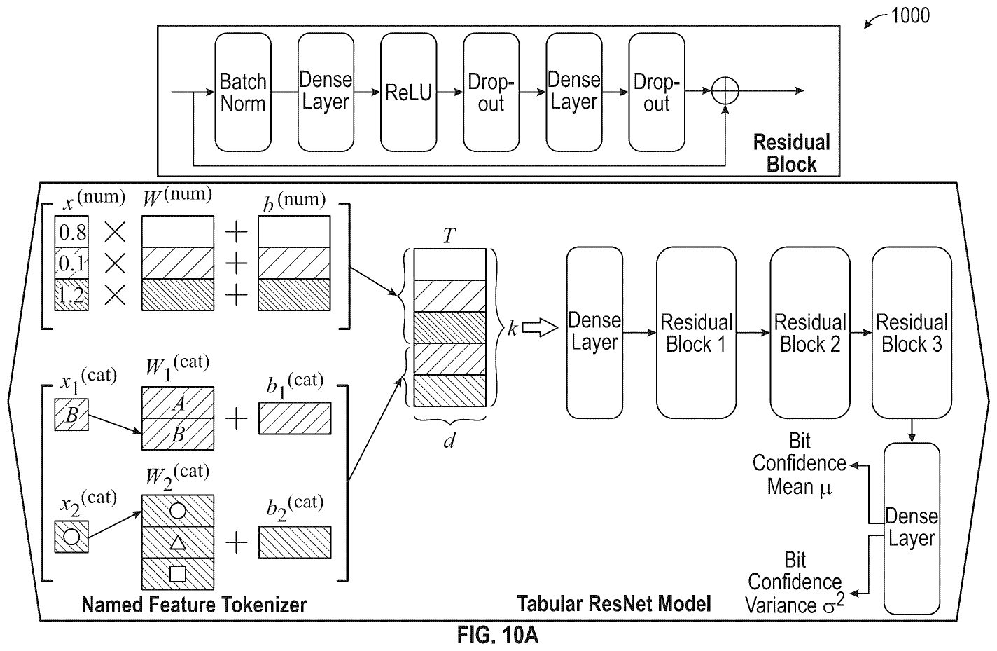

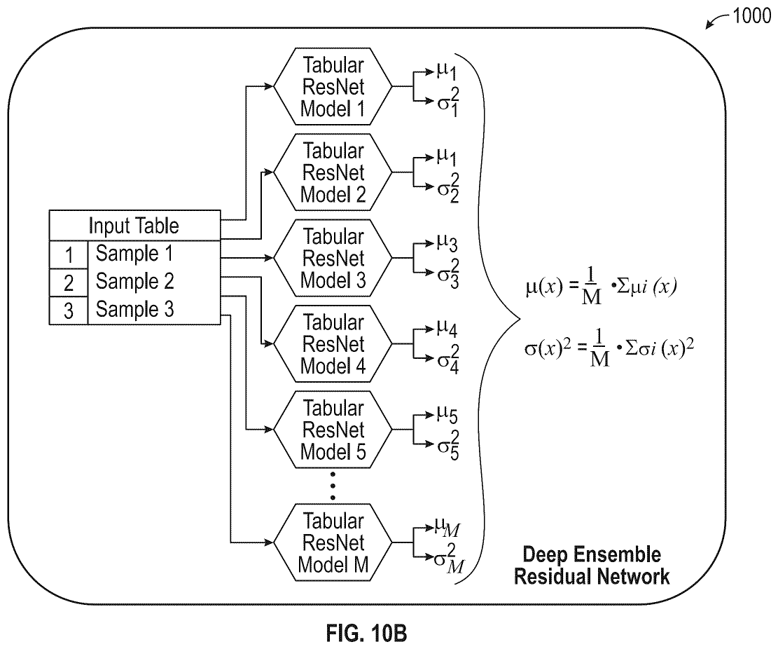

FIG. 10A and FIG. 10B shows an example of a workflow 1000 along with various blocks and a model architecture for a deep ensemble ResNet model, for example, an ensemble of ResNet models, which may be referred to as Deep-Ens-ResNet. As shown, input features can include various features such as, for example, one or more of telemetry related variables (e.g., tool characteristics, mode, frequency, bit rate, surface pipe dimensions, sensor position, etc.), mud properties (e.g., pressure, flow rate, density, viscosity, etc.), job operational parameters (e.g., section diameter, bottom depth, inclination, etc.), and one or more other inputs, additionally or alternatively.

In the example of FIG. 10A and FIG. 10B, the workflow shows a residual block as including various components, which may include batch normalization, dense layer, rectified linear unit (ReLU), dropout, dense layer and drop out components, where, for example, feedforward may be utilized (e.g., skipping). As explained, a residual block may be a skip-connection block that aims to learn a residual function with reference to layer input (e.g., rather than learning an unreferenced function); noting that a ResNet architecture includes one or more residual blocks. As explained, a ResNet architecture may address the vanishing gradient problem using one or more skip-connections. As an example, a ResNet architecture may stack multiple identity mappings (e.g., convolutional layers that do nothing at first), skip those layers, and reuse activations of a previous layer where skipping may speed up initial training by compressing the network into fewer layers. As an example, upon retraining, all layers may be expanded and remaining parts of the network (e.g., residual parts) may be allowed to explore more of a feature space of input.

As shown in the example of FIG. 10A and FIG. 10B, a feature tokenizer may be utilized. A feature tokenizer may be tailored as appropriate, noting that the example feature tokenizer shows three numerical and two categorical features being combined. As shown, the feature tokenizer can transform inputs (x) into embeddings (T). The embeddings of the input may be fed to a dense layer followed by a number of residual blocks followed by another dense layer where, for example, each of the residual blocks may include various components, for example, as explained above. As shown, the tabular ResNet model can generate output such as values for bit confidence mean and bit confidence variance.

As shown in the example of FIG. 10A and FIG. 10B, a deep ensemble ResNet architecture (Deep-Ens-ResNet) may be formed from a number of assembled components such as an ensemble of a number of tabular ResNet models. In such an example, input may be fed to the ensemble where output may be generated as to mean and variance by averaging individual outputs of each of the number of tabular ResNet models.

As to the number of ResNet models in the ensemble, it may be customizable (e.g., consider greater than two and less than twenty). In the example of FIG. 10A and FIG. 10B, the individual ResNet models may take the same features (e.g., input), however, they may be initialized with different weights at the start of training, which may thereby provide for differently weighted (e.g., trained) ResNet models that may provide for diversity of output. In such an approach, each of the ResNet models may have a common architecture yet capture aspects of data slightly differently given the diversity in initial weights amongst the individual ResNet models.

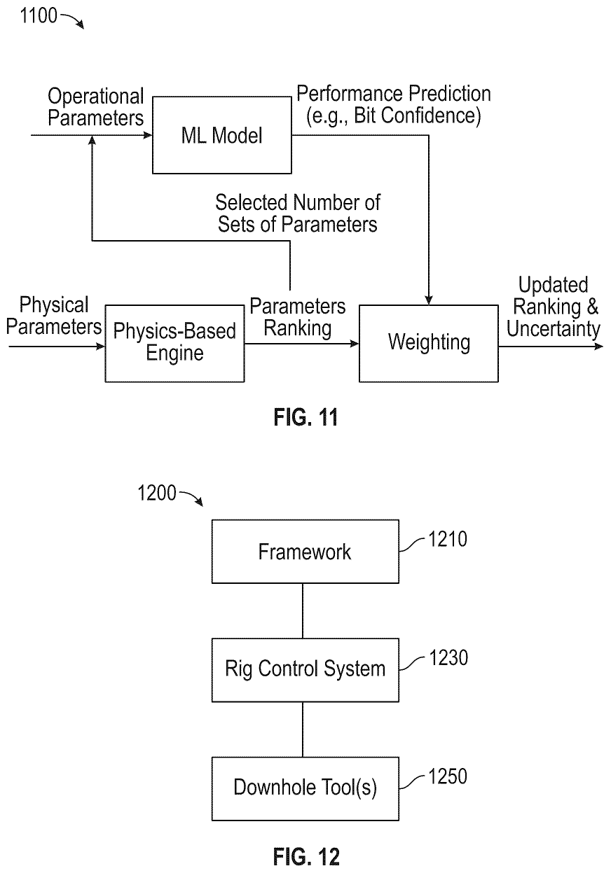

FIG. 11 shows an example workflow 1100 of a hybrid approach to controlling telemetry. As shown, the workflow 1100 includes receiving input by a trained ML model and receiving input by a physics-based engine such that weighting may be performed on outputs to generate an updated ranking of telemetry controls values, optionally along with uncertainty. For example, once a Deep-Ens-ResNet is trained on historical data, such a model may be utilized to obtain an estimation of bit confidence and its uncertainty that may be combined with physics-based engine outputs to rank telemetry parameters for control of an MPT system. As shown in the workflow 1100, output may be achieved by creating a weighted score using machine learning model-based and physics-based model predictions. In such an approach, a combination may consider uncertainty of an estimated bit confidence by giving less weight to a machine learning score where uncertainty values may be higher.

In the example of FIG. 11, the parameter ranking given by the physics-based engine is based on the physical parameters input, noting that input to the physics-based engine may include various parameters for MPT (e.g., frequency of signal, data rate, etc.). The physics-based engine may output MPT parameters that are expected to be reliable for a system that includes MPT equipment. For example, output may be or include one or more of modulation mode, data rate and frequency (e.g., a physics-based recommendation).

As to the operational parameters input to the ML model, they can be operational parameters for operation of a telemetry system (e.g., as within a physical environment characterized by the physical parameters input of the physics-based engine). As an example, various parameters may be input to the ML model (see, e.g., the example of Fig. FIG. 10A and FIG. 10B). For example, consider parameters as to current and/or past MPT performance, rig location, mud used during a job, etc.

In the example of FIG. 11, physics-based and data-driven outputs can be combined to improve MPT performance, whether via planning and/or control (e.g., section-to-section control, real-time control, etc.). As an example, output may include a listing of sets of parameters for MPT (e.g., data rate 1, frequency 2; data rate 2, frequency 1; etc.). As explained, the physics-based engine may output such sets in a ranked order, which may thereby effectively recommend one set over another. As an example, a field engineer may consider a top three ranked sets of parameters (e.g., MPT parameters). As shown, the ML model can generate performance predictions (e.g., bit confidence). As an example, the ML model may provide for assessing more than three top ranked sets of parameters, such as, for example, a top ten ranked sets of parameters. Output of the ML model may be utilized to weight a selected number of the ranked sets output by the physics-based model such that an updated ranking may be generated based at least in part on bit confidence predicted by the ML model, for example, along with uncertainty.

As an example, a method may include utilizing a trained residual network model for predicting mean and variance of the bit confidence (digital bit, not drill bit) where the residual network model may be composed of residual blocks that are characterized by skip connections. Such an approach may have the capability of reducing risk of experiencing the vanishing gradient problem, especially in the context of deep neural networks. As explained, a model may be trained to output mean and variance using a negative log-likelihood loss function.

As an example, a deep ensemble network may be utilized for a robust estimation of uncertainty. For example, consider an ensemble of residual neural networks randomly initialized or otherwise initialized to achieve an estimation of uncertainty. In such an example, output mean and variance may be aggregated for a final prediction.

As explained, a framework may implement a hybrid approach that combines machine learning-based model output and physics-based model output in a manner that considers uncertainty (e.g., in either or both outputs).

FIG. 12 shows an example of a system 1200 that includes a framework 1210, a rig control system 1230 and one or more downhole tools 1250. In such an example, the rig control system 1230 may provide for transmitting information to the framework (e.g., via a wired and/or wireless connection) whereby the framework 1210 generates one or more control parameters for telemetry. In such an example, the telemetry may be for transmissions to and/or transmissions from one or more of the one or more downhole tools 1250 where such telemetry may be controlled at least in part according to one or more of the one or more control parameters. In such an example, the system 1200 may provide for planning of operations and/or execution of operations where, for example, the framework 1210 may be implemented in a real-time manner for one or more field operations such as, for example, to determine optimal telemetry control parameters for one or more sections of a borehole being drilled or to be drilled. For example, if a change occurs in drilling fluid, the framework 1210 may be called and/or if a change occurs in one or more of section specifications, BHA equipment, etc., the framework 1210 may be called. As explained, various factors may impact telemetry, especially mud pulse telemetry. Such factors may be known a priori ahead of field operations and/or may be known once at least one or more field operations have commenced and/or be completed, which may, for example, result in one or more changes to a plan (e.g., a drilling plan that specifies equipment, techniques, etc., for drilling one or more sections of a borehole).

As an example, a framework may provide for assessing performance of an MPT system. For example, a hybrid planner may generate MPT parameter values for configuring an MPT system for transmissions during drilling operations for a section of a borehole. In such an example, one or more error metrics may be computed, which may be in real-time. As an example, one or more on-the-job error metrics may be compared against one or more expected error metrics as may be generated by a framework. In such an example, if a deviation occurs between on-the-job performance and expected performance, a system may call for re-planning MPT parameters, which may include assessing whether a deviation is due to an MPT system (e.g., MPT equipment) and/or one or more other factors (e.g., a change in mud density, in-flux of reservoir fluid into a borehole, etc.). In such an approach, a framework may provide for detection of one or more issues that may occur during drilling operations that may impact MPT performance. As an example, job data may be added to one or more databases, which may provide for additional training of one or more ML models and/or revising one or more physics-based models.

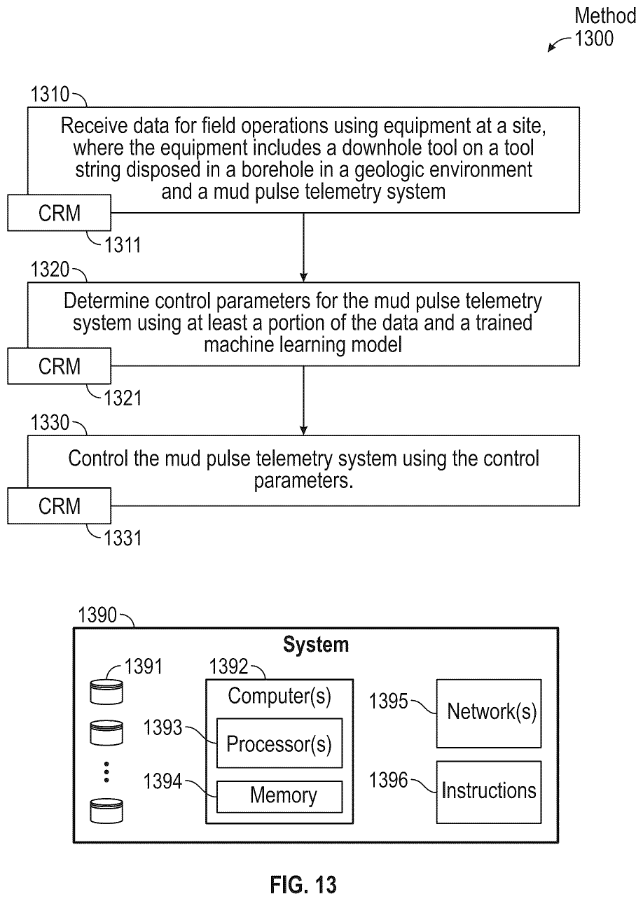

FIG. 13 shows an example of a method 1300 that includes a reception block 1310 for receiving data for field operations using equipment at a site, where the equipment includes a downhole tool on a tool string disposed in a borehole in a geologic environment and a mud pulse telemetry system; a determination block 1320 for determining control parameters for the mud pulse telemetry system using at least a portion of the data and a trained machine learning model; and a control block 1330 for controlling the mud pulse telemetry system using the control parameters.

FIG. 13 also shows various computer-readable media (CRM) blocks 1311, 1321, and 1331. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

In the example of FIG. 13, a system 1390 includes one or more information storage devices 1391, one or more computers 1392, one or more networks 1395 and instructions 1396. As to the one or more computers 1392, each computer may include one or more processors (e.g., or processing cores) 1393 and memory 1394 for storing the instructions 1396, for example, executable by at least one of the one or more processors. As an example, a computer may include one or more network interfaces (e.g., wired or wireless), one or more graphics cards, a display interface (e.g., wired or wireless), etc. The system 1390 may be specially configured to perform one or more portions of the method 1300 of FIG. 13.

As to types of machine learning models, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model (ML model), may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange to various other frameworks.

As an example, the TENSORFLOW framework (Google LLC, Mountain View, CA) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method may include various actions that may operate on a dataset to train a ML model. As an example, a dataset may be split into training data and test data where test data may provide for evaluation. A method may include cross-validation of parameters and best parameters, which may be provided for model training.

The TENSORFLOW framework may run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations may be expressed as stateful dataflow graphs; noting that the name TENSORFLOW derives from the operations that such neural networks perform on multidimensional data arrays. Such arrays may be referred to as “tensors”.

As an example, a method may include receiving data for field operations using equipment at a site, where the equipment includes a downhole tool on a tool string disposed in a borehole in a geologic environment and a mud pulse telemetry system; determining control parameters for the mud pulse telemetry system using at least a portion of the data and a trained machine learning model; and controlling the mud pulse telemetry system using the control parameters.

In such an example, the determining may include predicting mean digital bit confidence using the trained machine learning model. In such an example, the determining may include predicting variance of digital bit confidence using the trained machine learning model.

As an example, a trained machine learning model includes an ensemble model. In such an example, mean and variance of the ensemble model may provide an aggregated mean and an aggregated variance.

As an example, a method may include predicting variance of digital bit confidence in a manner that includes initializing individual models of the ensemble model randomly. For example, consider an approach to training that includes initializing individual models of an ensemble of models differently.

As an example, a method may include determining that includes generating predictions using a trained machine learning model by generating predictions using a physics-based model and combining the predictions based at least in part on uncertainty in the predictions. In such an example, combining may include weighting predictions of the physics-based model based at least in part on predictions of the trained machine learning model. As an example, a physics-based model may model at least attenuation of mud pulses.

As an example, a method may include determining that may account for modulation. For example, consider accounting for a modulation that may include PSK modulation (e.g., QPSK modulation, etc.).

As an example, control parameters may include one or more of telemetry mode, telemetry data rate, and telemetry frequency.

As an example, a trained machine learning model may include at least one residual block. In such an example, the at least one residual block may include at least one residual block characterized by one or more skip connections.

As an example, a trained machine learning model may be trained using a negative log-likelihood loss function.

As an example, a trained machine learning model may be trained using tabular data, where the tabular data include data from field operations performed at other sites. As an example, a trained machine learning model may be trained using a feature tokenizer that tokenizes at least a portion of the tabular data from categories into numbers.

As an example, a method may include controlling a mud pulse telemetry system to transmit sensor data acquired by a downhole tool via generation of mud pulses in drilling fluid disposed in a borehole, where a tool string includes a bore and where the drilling fluid is disposed in the bore.

As an example, a system can include a processor; memory accessible by the processor; processor-executable instructions stored in the memory and executable to instruct the system to: receive data for field operations using equipment at a site, where the equipment includes a downhole tool on a tool string disposed in a borehole in a geologic environment and a mud pulse telemetry system; determine control parameters for the mud pulse telemetry system using at least a portion of the data and a trained machine learning model; and control the mud pulse telemetry system using the control parameters.

As an example, one or more computer-readable storage media can include processor-executable instructions to instruct a computing system to: receive data for field operations using equipment at a site, where the equipment includes a downhole tool on a tool string disposed in a borehole in a geologic environment and a mud pulse telemetry system; determine control parameters for the mud pulse telemetry system using at least a portion of the data and a trained machine learning model; and control the mud pulse telemetry system using the control parameters.

As an example, a method may be implemented in part using computer-readable media (CRM), for example, as a module, a block, etc. that include information such as instructions suitable for execution by one or more processors (or processor cores) to instruct a computing device or system to perform one or more actions. As an example, a single medium may be configured with instructions to allow for, at least in part, performance of various actions of a method. As an example, a computer-readable medium (CRM) may be a computer-readable storage medium (e.g., a non-transitory medium) that is not a carrier wave. As an example, a computer-program product may include instructions suitable for execution by one or more processors (or processor cores) where the instructions may be executed to implement at least a portion of a method or methods.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

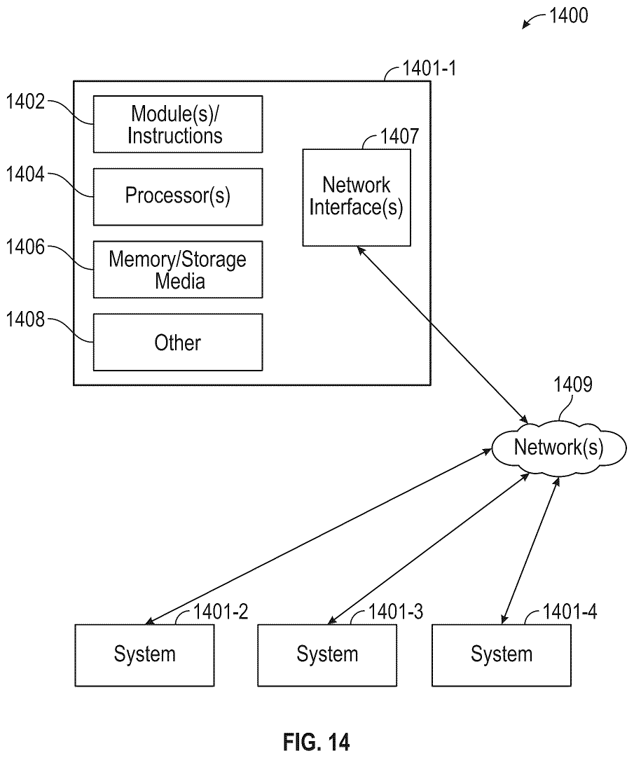

In some embodiments, a method or methods may be executed by a computing system. FIG. 14 shows an example of a system 1400 that may include one or more computing systems 1401-1, 1401-2, 1401-3 and 1401-4, which may be operatively coupled via one or more networks 1409, which may include wired and/or wireless networks.

As an example, a system may include an individual computer system or an arrangement of distributed computer systems. In the example of FIG. 14, the computer system 1401-1 may include one or more modules 1402, which may be or include processor-executable instructions, for example, executable to perform various tasks (e.g., receiving information, requesting information, processing information, simulation, outputting information, etc.).

As an example, a module may be executed independently, or in coordination with, one or more processors 1404, which is (or are) operatively coupled to one or more storage media 1406 (e.g., via wire, wirelessly, etc.). As an example, one or more of the one or more processors 1404 may be operatively coupled to at least one of one or more network interface 1407. In such an example, the computer system 1401-1 may transmit and/or receive information, for example, via the one or more networks 1409 (e.g., consider one or more of the Internet, a private network, a cellular network, a satellite network, etc.). As shown, one or more other components 1408 may be included in the computer system 1401-1.

As an example, the computer system 1401-1 may receive from and/or transmit information to one or more other devices, which may be or include, for example, one or more of the computer systems 1401-2, etc. A device may be located in a physical location that differs from that of the computer system 1401-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include general-purpose processors or application specific chips (e.g., or chipsets), such as ASICS, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving data for field operations using equipment at a site, wherein the equipment comprises a downhole tool on a tool string disposed in a borehole in a geologic environment and a mud pulse telemetry system;
determining control parameters for the mud pulse telemetry system using at least a portion of the data and a trained machine learning model; and
controlling the mud pulse telemetry system using the control parameters.

2. The method of claim 1, wherein the determining comprises predicting mean digital bit confidence using the trained machine learning model.

3. The method of claim 2, wherein the determining comprises predicting variance of digital bit confidence using the trained machine learning model.

4. The method of claim 3, wherein the trained machine learning model comprises an ensemble model.

5. The method of claim 4, wherein the mean and the variance of the ensemble model comprise an aggregated mean and an aggregated variance.

6. The method of claim 4, wherein the predicting variance of the digital bit confidence comprises initializing individual models of the ensemble model randomly.

7. The method of claim 1, wherein the determining comprises generating predictions using the trained machine learning model, generating predictions using a physics-based model, and combining the predictions based at least in part on uncertainty in the predictions.

8. The method of claim 7, wherein the combining comprises weighting the predictions of the physics-based model based at least in part on the predictions of the trained machine learning model.

9. The method of claim 7, wherein the physics-based model models at least attenuation of mud pulses.

10. The method of claim 1, wherein the determining accounts for modulation.

11. The method of claim 10, wherein the modulation comprises QPSK modulation.

12. The method of claim 1, wherein the control parameters comprise one or more of telemetry mode, telemetry data rate, and telemetry frequency.

13. The method of claim 1, wherein the trained machine learning model comprises at least one residual block.

14. The method of claim 13, wherein the at least one residual block comprises at least one residual block characterized by one or more skip connections.

15. The method of claim 1, wherein the trained machine learning model is trained using a negative log-likelihood loss function.

16. The method of claim 1, wherein the trained machine learning model is trained using tabular data, wherein the tabular data comprise data from field operations performed at other sites.

17. The method of claim 16, wherein the trained machine learning model is trained using a feature tokenizer that tokenizes at least a portion of the tabular data from categories into numbers.

18. The method of claim 1, wherein the controlling comprises controlling the mud pulse telemetry system to transmit sensor data acquired by the downhole tool via generation of mud pulses in drilling fluid disposed in the borehole, wherein the tool string comprises a bore and wherein the drilling fluid is disposed in the bore.

19. A system comprising:
a processor;
memory accessible by the processor;
processor-executable instructions stored in the memory and executable to instruct the system to:
receive data for field operations using equipment at a site, wherein the equipment comprises a downhole tool on a tool string disposed in a borehole in a geologic environment and a mud pulse telemetry system;
determine control parameters for the mud pulse telemetry system using at least a portion of the data and a trained machine learning model; and
control the mud pulse telemetry system using the control parameters.

20. One or more computer-readable storage media comprising processor-executable instructions to instruct a computing system to:
receive data for field operations using equipment at a site, wherein the equipment comprises a downhole tool on a tool string disposed in a borehole in a geologic environment and a mud pulse telemetry system;
determine control parameters for the mud pulse telemetry system using at least a portion of the data and a trained machine learning model; and
control the mud pulse telemetry system using the control parameters.
